(19) United States
(12) Patent Application Publication
(10) Pub. No.: US 2023/0359969 A1
(43) Pub. Date: Nov. 9, 2023

(54) WORK PLANNING METHOD, NON-TRANSITORY COMPUTER-READABLE RECORDING MEDIUM STORING WORK PLANNING PROGRAM, AND INFORMATION PROCESSING DEVICE

(71) Applicant: FUJITSU LIMITED, Kawasaki-shi (JP)

(72) Inventor: Takashi YAMAZAKI, Kawasaki (JP)

(73) Assignee: FUJITSU LIMITED, Kawasaki-shi (JP)

(21) Appl. No.: 18/353,914

(22) Filed: Jul. 18, 2023

Related U.S. Application Data
(63) Continuation of application No. PCT/JP2021/012578, filed on Mar. 25, 2021.

(51) Int. Cl. G06Q 10/0631

(52) U.S. Cl. CPC G06Q 10/06316; G06Q 50/28

(57) ABSTRACT

A method implemented by a computer planning a loading order of objects on a condition that, in a work line into which the objects having a work time are sequentially loaded at intervals of a first time, work on each object is sequentially started, and work on the objects except an object to be loaded at last is completed within a second time, the method including: allocating objects to any of the blocks; and retrieving the loading order by rearranging an order of the objects in each object, and rearranging an order of the blocks, wherein the allocating includes setting, for each block, a total of the work times for the objects to be shorter than a value of a product of the first time and the number of objects, and setting the number of the blocks to be at least two and smaller than the number of the objects.

### CROSS-REFERENCE TO RELATED APPLICATION

This application is a continuation application of International Application PCT/JP2021/012578 filed on Mar. 25, 2021 and designated the U.S., the entire contents of which are incorporated herein by reference.

### FIELD

This case relates to a work planning method, a non-transitory computer-readable recording medium storing a work planning program, and an information processing device.

### BACKGROUND

In multi-product mixed line operations, techniques for generating an order of objects to be loaded into a work line in accordance with a planning algorithm are being demanded (see Patent Documents 1 and 2, for example).

Examples of the related art include: [Patent Document 1] Japanese Laid-open Patent Publication No. 2002-215860; and [Patent Document 2] Japanese Laid-open Patent Publication No. 2004-195615.

### SUMMARY

According to an aspect of the embodiments, there is provided a work planning method implemented by a computer that plans a loading order of a plurality of objects on a condition that, in a work line into which the plurality of objects each of which has a predetermined work time are sequentially loaded at intervals of a first time, work on the object to be loaded next is not started until work on the object loaded previously is completed, and work on the objects other than the object to be loaded at last among the plurality of objects is completed within a second time that is longer than the first time, after the object is loaded into the work line. In ax example, the work planning method includes: performing, by the computer, an allocation processing that allocates the plurality of objects to any block of a plurality of blocks; and performing, by the computer, a retrieval processing that retrieves the loading order by rearranging an order of the objects included in each block of the plurality of blocks, and rearranging an order of the plurality of blocks, wherein the allocation processing performed by the computer includes setting a total of the work times for the objects included in each block to be equal to or shorter than a value of a product of the number of objects included in each block and the first time, and setting the number of blocks in the plurality of blocks to be at least two and smaller than the number of objects in the plurality of objects.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of product takts;

FIG. 2 is a diagram illustrating an example of line-out;

FIGS. 3A and 3B are diagrams illustrating an example of division of a loading order into blocks;

FIG. 4A is a block diagram illustrating an example of the overall configuration of an information processing device, and FIG. 4B is a block diagram illustrating an example of the hardware configuration of the information processing device;

FIG. 5 is a flowchart illustrating an example of a work planning process to be performed by the information processing device;

FIG. 6 is a diagram illustrating an example of block generation;

FIG. 7 is a diagram illustrating an example of optimization of an input order;

FIG. 8 is a flowchart illustrating an example of details of step S3;

FIG. 9 illustrates another example of a work planning process to be performed by the information processing device;

FIG. 10 is a verification result in a complicated example; and

FIG. 11 is a result of optimizing the order of blocks by rearranging the order of products in the blocks.

### DESCRIPTION OF EMBODIMENTS

In a takt-time work in which objects are loaded into the work line at regular time intervals, there are cases where the work line is stopped before the work on some objects is completed within a prescribed time, depending on the loading order. In such cases, the total work time is greatly affected. However, if the loading order is to be verified as to all combinations of all products, a great amount of calculation time is required.

In one aspect, an object of this case is to provide a work planning method, a work planning program, and an information processing device that are capable of making a work plan so as not to increase the calculation time.

In a case where multi-product mixed line manufacturing is performed, the product types changes many times during a certain period of time. Therefore, products of different types are mixed and loaded into the same work line. In such a mixed-flow operation factory, the required work time varies with each product. Hereinafter, the work time required by a product will be referred to as a product takt.

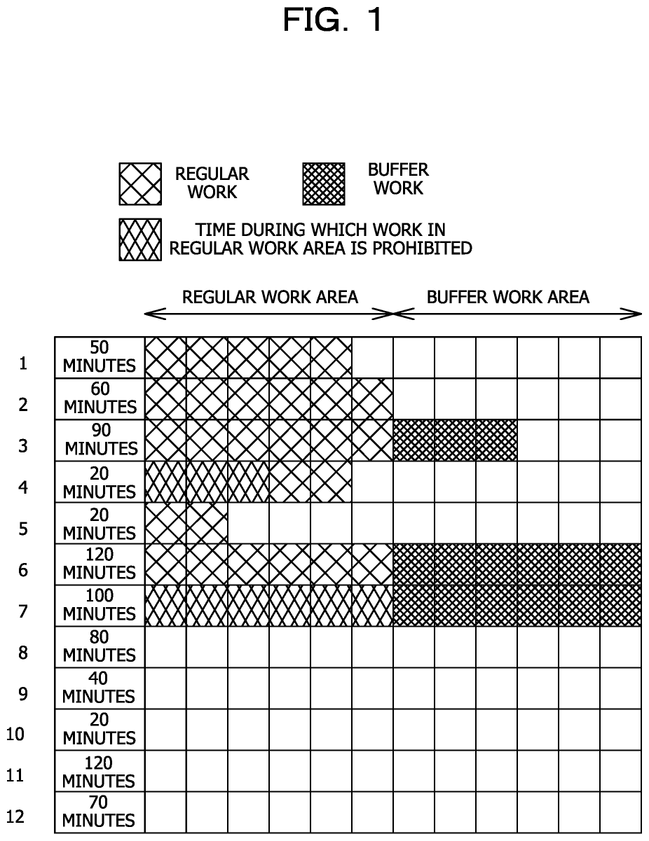

For example, as illustrated in an example in FIG. 1, the product takt differs for each product. For example, the product takt of product 1 is 50 minutes, the product takt of product 2 is 60 minutes, and the product takt of product 3 is 90 minutes. The numbers of the product 1 to the product 12 indicate the order of loading into the work line.

To perform production without stopping the line in a work line in which takt-time production is performed by loading products into the work line at regular time intervals (takt time), a line design is made as an example so that a regular work area equal to the takt time, and a buffer work area that is an additional work time allowed in a case where work does not catch up in the regular work area are set in equal periods.

In the example in FIG. 1, the regular work area and the buffer work area are each set to 60 minutes. If the product takt of each product falls within the regular work area, the work on each product is completed within the regular work area, and accordingly, a work waiting time is not caused for the product to be next loaded into the work line. However, there is a work waiting time until the worker starts work on each product.

Products on which work is not completed in the regular work area are subjected to work in the buffer work area. However, in a case where work is conducted in the buffer work area, there is a time during which work cannot be performed on the product to be next loaded into the work line. Therefore, it is expected to consider the product loading order, taking into account the buffer work time of the previous product in addition to the original work time of the next product. In a case where this loading order is not appropriate, and the work on the product is not completed in the buffer work area, a process of stopping the entire work line is performed to prevent a work time from being taken for the next process. This process of stopping the entire work line is called line-out. Line-out occurs when the work is not completed within a predetermined time exceeding the takt time after the product is loaded into the work line. For example, line-out occurs in a case where the work is not completed within (takt time×2) after the product is loaded into the work line.

For example, since the product takt of product 3 is 90 minutes, it is necessary to perform additional work beyond the regular production area. During the period in which the additional work is performed, any work on product 4 cannot be performed. Therefore, a work waiting time is caused for product 4. However, the product takt of product 4 to be next loaded is short. Accordingly, the work on product 4 can be completed within the regular work area, even though the work waiting time is caused for product 4. In this case, no line-out occurs.

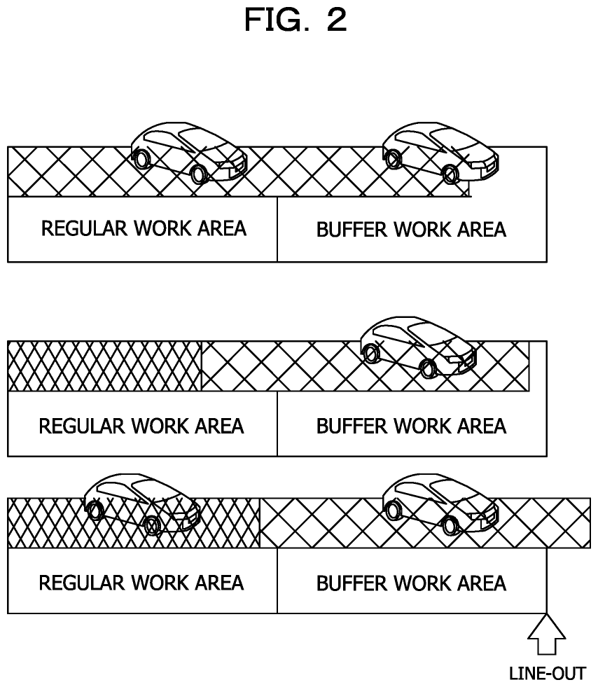

Since the product takt of product 6 is 120 minutes, it is possible to complete the work on product 6 by performing additional work in the buffer work area. Since the work of product 7 cannot be started during the period in which the additional work is performed, a work waiting time is caused for product 7. Since the product takt of this product 7 is 100 minutes, it is not possible to complete the work even by using all the allowed buffer work area. Therefore, line-out occurs, as illustrated in an example in FIG. 2.

Line-out has a significant impact on the work time to complete the work on all products. On the other hand, even if the work in the regular work area is completed early, the products are loaded periodically. Therefore, in a case where the work is finished early, a work waiting time is caused for the worker. In the work line, it is desirable to determine a product loading order that does not cause line-out while minimizing the work waiting time.

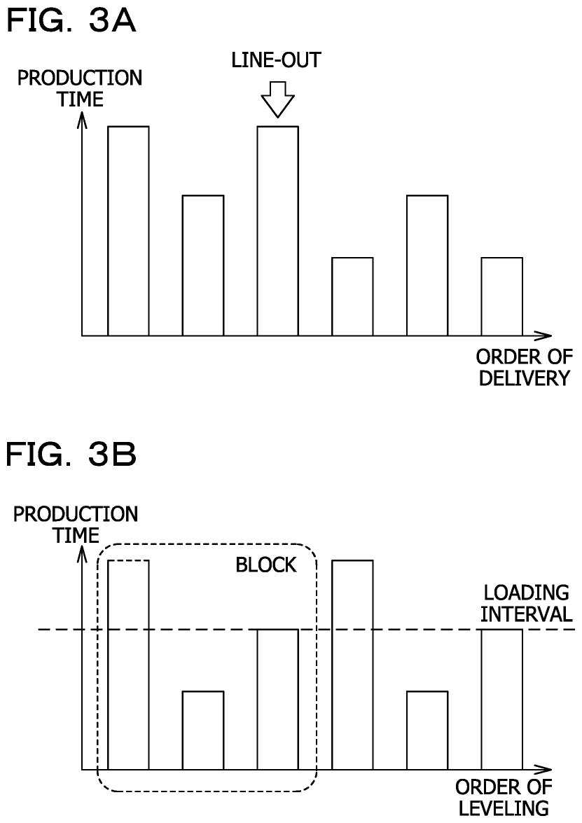

FIG. 3A is a diagram illustrating an example case where products are loaded in order of delivery. When products are loaded in order of delivery, products with longer work times might be subsequently loaded into the work line. In this case, line-out might occur. Therefore, it is conceivable to retrieve a loading order in which no line-out occurs, by searching loading orders of all combinations of all products. In this case, however, the number of combinations is enormous, and the calculation time is very long.

In view of this, as illustrated in an example in FIG. 3B, it is conceivable to determine a product loading order that is the order of a product with a long product takt, a product with a short product takt, and a product with an average product takt. Each of three products rearranged in the order of a long product takt, a short product takt, and an average product takt is referred to as a block.

However, as the variation in the multi-product mixed line work progresses, when the block size is fixed, it is difficult to create a product group with the minimum deviation. Also, line-out is less likely to occur only by leveling, but the delivery date serves as another index. Therefore, the delivery date cannot be always kept. Further, even if the order in a block is considered in the order of a long product takt, a short product takt, and an average product takt, line-out is not always prevented. Therefore, it is necessary to perform calculation by rearranging the order in the block.

In view of the above, the embodiment described below concerns a work planning method, a work planning program, and an information processing device that are capable of making a work plan so as not to increase the calculation time.

### First Embodiment

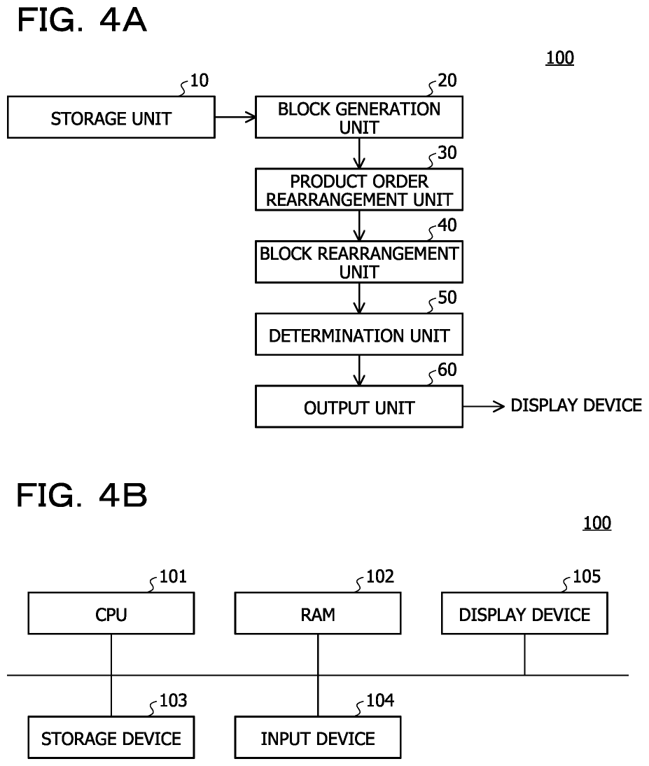

FIG. 4A is a block diagram illustrating an example of the overall configuration of an information processing device 100. As illustrated in the example in FIG. 4A, the information processing device 100 includes a storage unit 10, a block generation unit 20, a product order rearrangement unit 30, a block rearrangement unit 40, a determination unit 50, an output unit 60, and the like.

FIG. 4B is a block diagram illustrating an example of the hardware configuration of the storage unit 10, the block generation unit 20, the product order rearrangement unit 30, the block rearrangement unit 40, the determination unit 50, and the output unit 60 of the information processing device 100. As illustrated in the example in FIG. 4(b), the information processing device 100 includes a CPU 101, a RAM 102, a storage device 103, an input device 104, a display device 105, and the like.

The CPU (Central Processing Unit) 101 is a central processing unit. The CPU 101 includes one or more cores. The RAM (Random Access Memory) 102 is a volatile memory that temporarily stores a program to be executed by the CPU 101, data to be processed by the CPU 101, and the like. The storage device 103 is a nonvolatile storage device. For example, a read only memory (ROM), a solid state drive (SSD) such as a flash memory, a hard disk to be driven by a hard disk drive, or the like may be used as the storage device 103. The storage device 103 stores a work planning program. The input device 104 is an input device such as a keyboard or a mouse. The display device 105 is a display device such as a liquid crystal display (LCD). The CPU 101 executes the work planning program, to implement the storage unit 10, the block generation unit 20, the product order rearrangement unit 30, the block rearrangement unit 40, the determination unit 50, and the output unit 60. Note that hardware such as a dedicated circuit may be used as the storage unit 10, the block generation unit 20, the product order rearrangement unit 30, the block rearrangement unit 40, the determination unit 50, and the output unit 60.

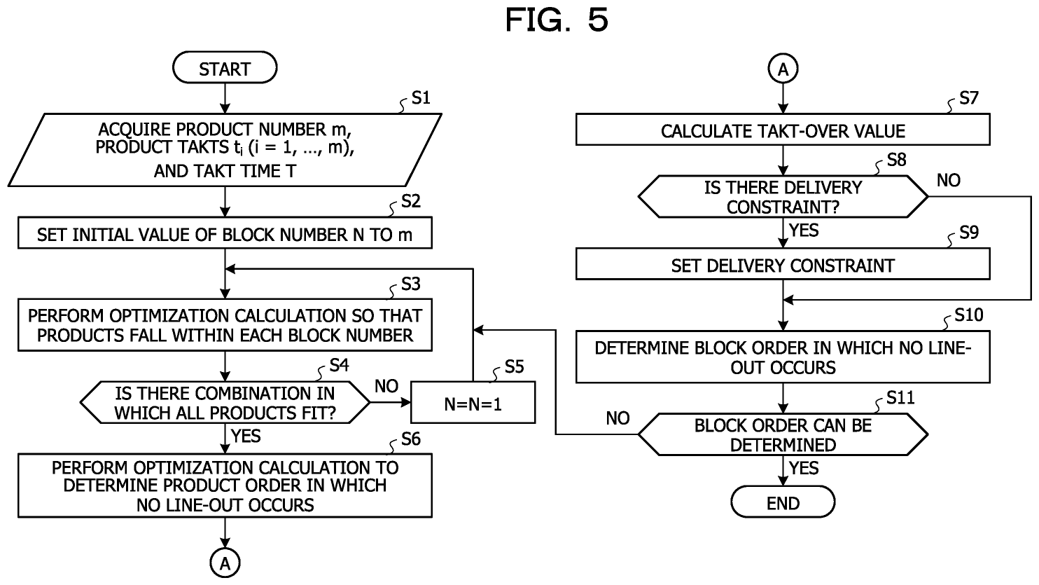

FIG. 5 is a flowchart illustrating an example of a work planning process to be performed by the information processing device 100. First, the block generation unit 20 receives the number m of products, the product takt tᵢ (i=1 to m) of each product, and a takt time T (step S1). These pieces of information are input via the input device 104. The number m of products is the total number of products to be loaded into the work line. A product number i is assigned to each product. A product takt t is set for each product. The product takts of some products are above the takt time T, and the product takts of some other products are below the takt time T.

Next, the block generation unit 20 sets the initial value of the number N of blocks to the number m of products (step S2). As a result, a possible maximum value of the number N of blocks is first set.

Next, the block generation unit 20 performs an optimization calculation using the number N of blocks and the number nₓ of products in each block as variables (step S3). The constraint condition for the optimization calculation is T×nₓ≥Σtᵢ. Here, “x” represents the block number, and is a value from 1 to N. The “tᵢ” in the constraint condition is the number of the products contained in the block. Accordingly, in the process of the optimization calculation, where the product numbers 1, 2, and 3 are included in block 1, for example, Σtᵢ is tᵢ+t₂+t₃. For example, in a case where the product numbers 1, 3, and 5 are included in block 1, Σtᵢ is tᵢ+t₃+t₅. Therefore, as the constraint condition, T×nₓ≥Σtᵢ, is provided, the total product takt of each product is equal to or smaller than the product of the number of products in the block and the takt time in each block. That is, in each block, the condition under which line-out is difficult is set.

Next, the block generation unit 20 determines whether there is a combination in which all products fit in each block as a result of the optimization calculation in step S3 (step S4). Since the product takts of some products exceed the takt time T, if the number N of blocks is the initial value, which is the number m of products, the determination result is “No” in step S4.

If the determination result is “No” in step S4, the block generation unit 20 reduces the number N of blocks by 1 (step S5). After that, step S3 and the subsequent steps are again carried out. As steps S3 to S5 are repeatedly carried out, the maximum number N of blocks satisfying T×nₓ≥Σtᵢ, which is the constraint condition, is obtained.

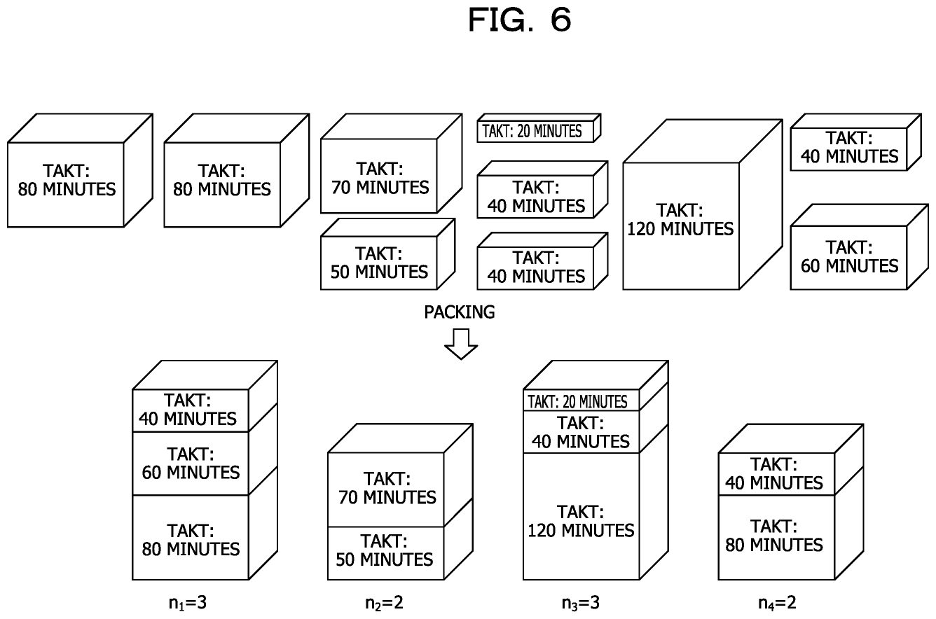

For example, in an example in FIG. 6, the number of blocks that can be packed with ten products is four. For example, in block 1, the number n₁ of products is three, and the condition of T×n₁≥(40 minutes+60 minutes+80 minutes) is satisfied. In block 2, the number n₂ of products is two, and the condition of T×n₂≥(70 minutes+50 minutes) is satisfied.

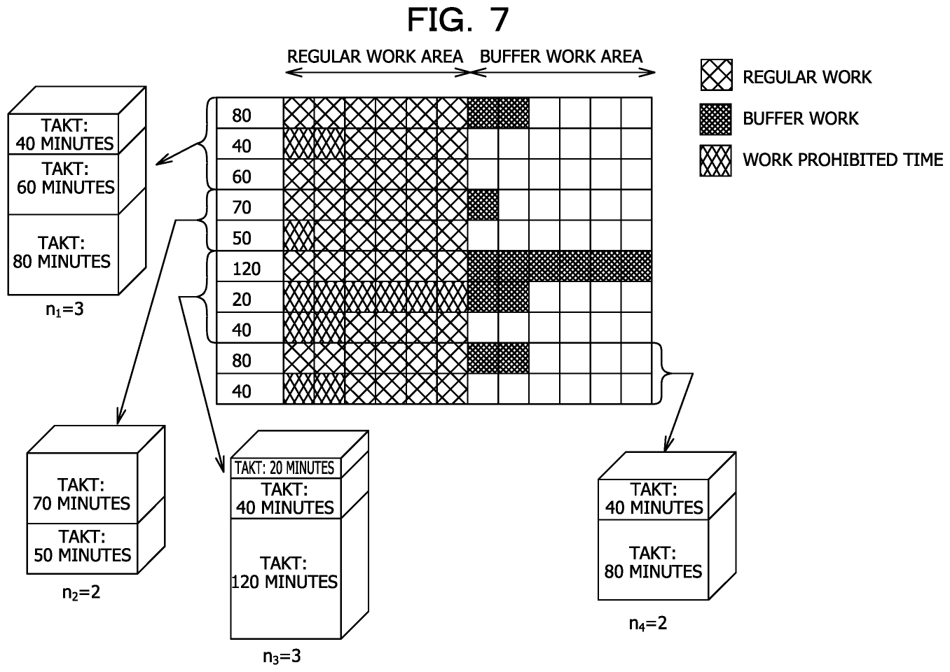

If the determination result is “Yes” in step S4, the product order rearrangement unit 30 changes the product order in the block for each block, and calculates the order in which no line-out occurs by the optimization calculation (step S6). In an example in FIG. 7, no line-out has occurred in any block. Note that, even if the order in which no line-out occurs is determined, there are cases where the work on the last product in the block is not completed in the regular work area, but is completed in a buffer work area.

Next, the block rearrangement unit 40 calculates a takt-over value for each block (step S7). The takt-over value is the time for the last product to go beyond the regular work area in each block. In a case where the work on the last product is completed in the regular work area, the takt-over value is zero.

Next, the block rearrangement unit 40 determines whether a delivery constraint is input (step S8). If the determination result is “Yes” in step S8, the block rearrangement unit 40 sets a delivery constraint (step S9). If the determination result is “No” in step S8, the block rearrangement unit 40 does not set any delivery constraint. The delivery constraint is input via the input device 104.

Next, the block rearrangement unit 40 determines a block order in which no line-out occurs, by performing block order rearrangement (step S10). In a case where a delivery constraint is set, the block rearrangement unit 40 rearranges the block order so that the delivery date is met.

Next, the determination unit 50 determines whether the block order can be determined in step S10 (step S11). If the determination result is “No” in step S11, step S5 and the subsequent steps are again carried out. If the determination result is “Yes” in step S11, the output unit 60 outputs the determined block order and the product order. The output information is displayed on the display device 105.

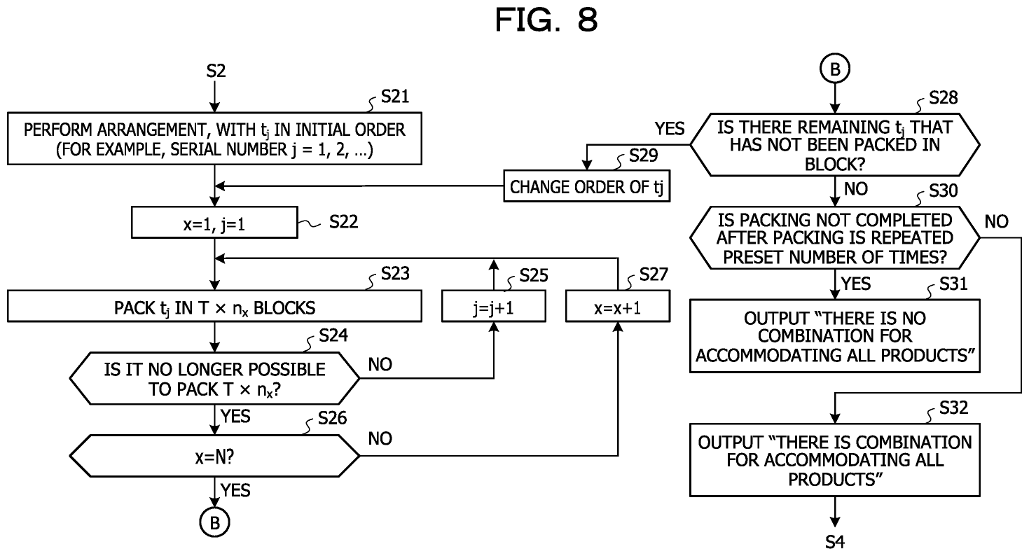

FIG. 8 is a flowchart illustrating an example of details of the optimization calculation in step S3. As illustrated in the example in FIG. 8, the block generation unit 20 performs arrangement in the order of product takts tⱼ (serial numbers j=1, 2, . . . , m) (step S21). Next, the block generation unit 20 sets x=1 and j=1 (step S22). Next, the block generation unit 20 packs the blocks having the time T×nₓ with tⱼ (step S23).

Next, the block generation unit 20 determines whether it is no longer possible to pack T×nₓ (step S24). If the determination process is “No” in step S24, the block generation unit 20 adds 1 to j (step S25). After that, step S23 and the subsequent steps are again carried out.

If the determination result is “Yes” in step S24, the block generation unit 20 determines whether x=N (step S26). If the determination result is “No” in step S26, the block generation unit 20 adds 1 to x (step S27). After that, step S23 and the subsequent steps are again carried out.

If the determination result is “Yes” in step S26, the block generation unit 20 determines whether there is tⱼ that has not been packed in the blocks (step S28). If the determination result is “Yes” in step S28, the order of tⱼ is changed (step S29). After that, step S22 and the subsequent steps are again carried out.

If the determination result is “No” in step S28, the block generation unit 20 determines whether packing is not completed after packing is repeated the preset number of times (step S30). If the determination result is “Yes” in step S30, the block generation unit 20 outputs information indicating that “there is not a combination for accommodating all products” (step S31). If the determination result is “No” in step S30, information indicating that “there is a combination for accommodating all products” is output (step S32).

According to this embodiment, a plurality of blocks is prepared, and optimization is performed to accommodate all products in the plurality of blocks so that the total product takt of each product in each block becomes equal to or less than (the number of objects in the block×takt time). The order of the blocks formed in this manner is rearranged for each block while the product orders in the blocks are also rearranged, so that an optimized product loading order can be obtained as a whole. Also, as the orders in the blocks are rearranged, verification of the order of loading all the combinations of all the products becomes unnecessary. Accordingly, it is possible to prevent an increase in calculation time. In view of above, according to this embodiment, it is possible to prepare a work plan while preventing an increase in calculation time.

Note that one of the purposes of rearranging the orders in the blocks is to minimize the waiting time. As for this order rearrangement, it is desirable to take into account the constraint or the like on the order of loading the products. However, when a constraint violation in the blocks is avoided, it is possible to make a plan that does not cause a constraint violation, by increasing the number of blocks as much as possible.

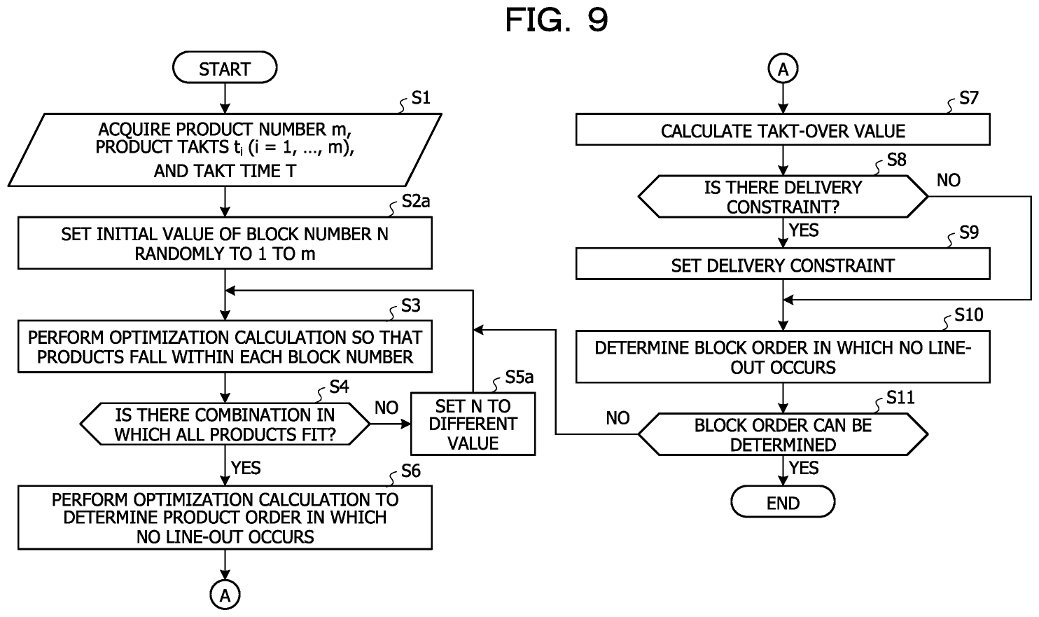

The block generation unit 20 generates blocks so that the number of blocks is at least two or greater but is smaller than the number m of products. For example, as illustrated in an example in FIG. 9, the block generation unit 20 may carry out step S2a, instead of step S2. In step S2a, one of 1 to m is randomly set as the initial value of the number N of blocks. In this case, the block generation unit 20 carries out step S5a, instead of step S5. In step S5a, N is set to a value different from the current value.

However, as illustrated in the example in FIG. 5, maximizing the number of blocks reduces the number of products in each block. In this case, the optimization by order rearrangement in the blocks can be easily performed, and the calculation time can be further shortened.

Note that, in the above example, blocks are generated so that T×nₓ≥Σtᵢ, which is the constraint condition for the optimization calculation, is satisfied in all the blocks in step S3, but the present invention is not limited to that. For example, T×nₓ≥Σtᵢ may not be satisfied in one block. This is because, even if the work on the last product is not completed in the buffer work area, there is no product to be input next, and therefore, line-out will not occur. In this case, at the time of the optimization calculation in step S6, the work may not be completed in the buffer work area for the last product.

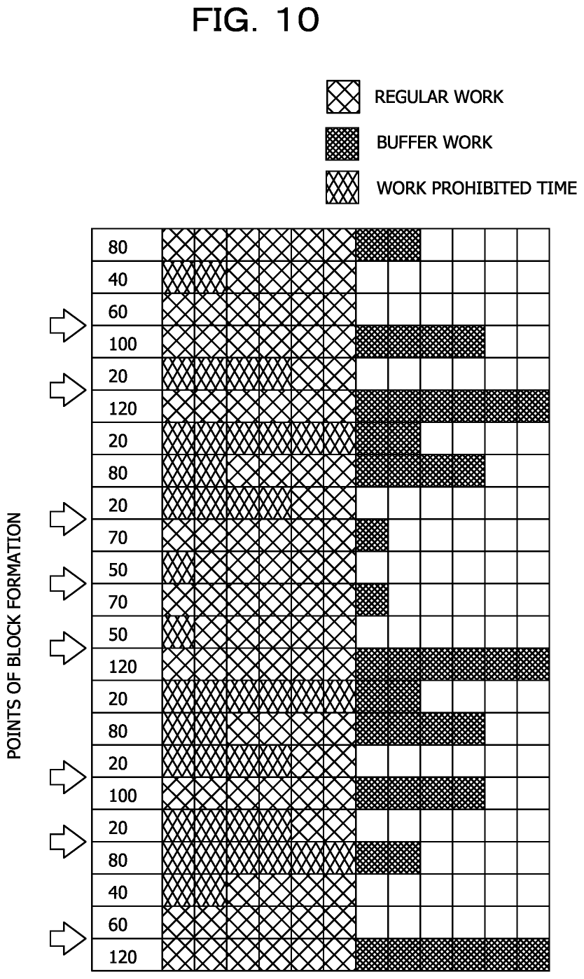

FIG. 10 is a verification result in a more complicated example. There are eight product types from A to H. For product type A, the number of products is six, and the product takt is 20 minutes. For product type B, the number of products is two, and the product takt is 40 minutes. For product type C, the number of products is two, and the product takt is 50 minutes. For product type D, the number of products is two, and the product takt is 60 minutes. For product type E, the number of products is two, and the product takt is 80 minutes. For the product type F, the number of products is four, and the product takt is 80 minutes. For product type G, the number of products is two, and the product takt is 100 minutes. For product type H, the number of products is three, and the product takt is 120 minutes. The total number of products is 23.

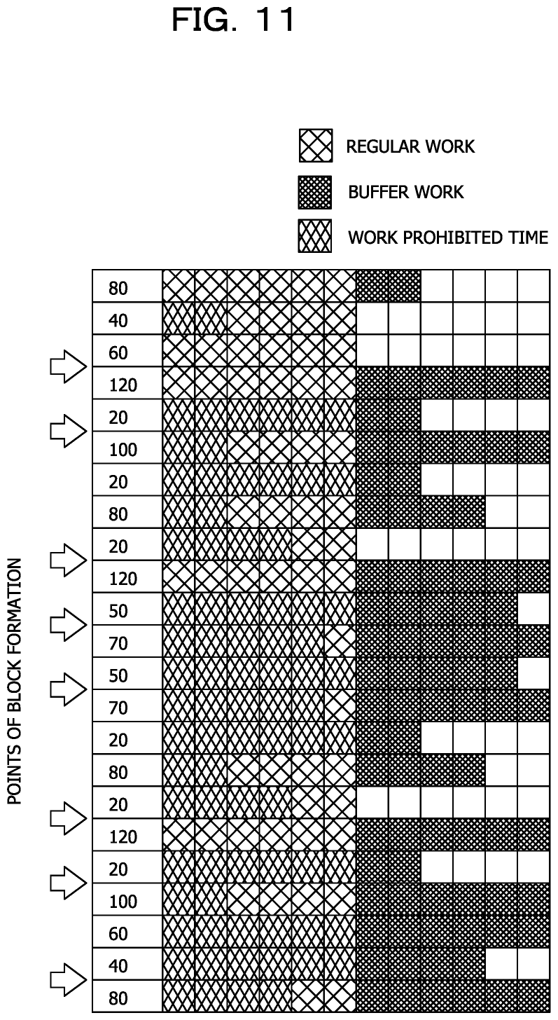

Meanwhile, an optimization calculation that maximizes the number of blocks was performed. In this case, a condition that T×nₓ≥Σtᵢ, may not be satisfied in one block is set. As a result of the optimization calculation, the number of blocks becomes eight. If the products are ideally accommodated in the respective blocks, the order of the products in the block is rearranged in the order of a large product takt, a small product takt, and an intermediate product takt, so that the product loading order in which no line-out occurs is determined. FIG. 11 is a result of optimizing the order of blocks by rearranging the order of products in the blocks. An optimum solution is obtained by a calculation involving several thousands of steps.

With simulation software using a genetic algorithm, a work plan that does not cause line-out was calculated for 23! loading orders, without the use of the concept of blocks. Although trials were performed for 100 generations of 1000 individual pieces=100000 times, any solution was not obtained.

In the above example, the takt time T is an example of the first time. The sum of the regular work area and the buffer work area is an example of the second time. The block generation unit 20 is an example of the allocation unit that allocates the plurality of objects to any of a plurality of blocks. The product order rearrangement unit 30, the block rearrangement unit 40, and the determination unit 50 are an example of the retrieval unit that retrieves the loading order by rearranging the order of the objects included in each block of the plurality of blocks, and rearranging the order of the plurality of blocks.

Although an embodiment of the present invention has been described above in detail, the present embodiment is not limited to the specific embodiment, and various modifications and changes may be made to it within the scope of the present invention disclosed in the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A work planning method implemented by a computer that plans a loading order of a plurality of objects on a condition that, in a work line into which the plurality of objects each of which has a predetermined work time are sequentially loaded at intervals of a first time, work on the object to be loaded next is not started until work on the object loaded previously is completed, and work on the objects other than the object to be loaded at last among the plurality of objects is completed within a second time that is longer than the first time, after the object is loaded into the work line, the work planning method comprising:
performing, by the computer, an allocation processing that allocates the plurality of objects to any block of a plurality of blocks; and
performing, by the computer, a retrieval processing that retrieves the loading order by rearranging an order of the objects included in each block of the plurality of blocks, and rearranging an order of the plurality of blocks,
wherein the allocation processing performed by the computer includes setting a total of the work times for the objects included in each block to be equal to or shorter than a value of a product of the number of objects included in each block and the first time, and setting the number of blocks in the plurality of blocks to be at least two and smaller than the number of objects in the plurality of objects.

2. The work planning method according to claim 1, wherein the allocation processing performed by the computer includes setting the number of blocks in the plurality of blocks to a maximum number, under a condition that a total of the work times for the objects included in each block is equal to or shorter than a value of a product of the number of objects included in each block and the first time.

3. The work planning method according to claim 1, wherein the retrieval processing performed by the computer includes retrieving the loading order based on a constraint condition for a work order of the objects.

4. The work planning method according to claim 1, further comprising performing, by the computer, a display processing that displays a result of retrieval of the loading order.

5. A non-transitory computer-readable recording medium storing a work planning program for causing a computer to perform processing, the computer being configured to plan a loading order of a plurality of objects on a condition that, in a work line into which the plurality of objects each of which has a predetermined work time are sequentially loaded at intervals of a first time, work on the object to be loaded next is not started until work on the object loaded previously is completed, and work on the objects other than the object to be loaded at last among the plurality of objects is completed within a second time that is longer than the first time, after the object is loaded into the work line, the processing comprising:
performing, by the computer, an allocation processing that allocates the plurality of objects to any block of a plurality of blocks; and
performing, by the computer, a retrieval processing that retrieves the loading order by rearranging an order of the objects included in each block of the plurality of blocks, and rearranging an order of the plurality of blocks,
wherein the allocation processing performed by the computer includes setting a total of the work times for the objects included in each block to be equal to or shorter than a value of a product of the number of objects included in each block and the first time, and setting the number of blocks in the plurality of blocks to be at least two and smaller than the number of objects in the plurality of objects.

6. The non-transitory computer-readable recording medium according to claim 5, wherein the allocation processing performed by the computer includes setting the number of blocks in the plurality of blocks to a maximum number, under a condition that a total of the work times for the objects included in each block is equal to or shorter than a value of a product of the number of objects included in each block and the first time.

7. The non-transitory computer-readable recording medium according to claim 5, wherein the retrieval processing performed by the computer includes retrieving the loading order based on a constraint condition for a work order of the objects.

8. The non-transitory computer-readable recording medium according to claim 5, further comprising performing, by the computer, a display processing that displays a result of retrieval of the loading order.

9. An information processing device that plans a loading order of a plurality of objects on a condition that, in a work line into which the plurality of objects each of which has a predetermined work time are sequentially loaded at intervals of a first time, work on the object to be loaded next is not started until work on the object loaded previously is completed, and work on the objects other than the object to be loaded at last among the plurality of objects is completed within a second time that is longer than the first time, after the object is loaded into the work line,
the information processing device comprising:
a memory; and
a processor coupled to the memory, the processor being configured to be operable as:
an allocation unit that allocates the plurality of objects to any block of a plurality of blocks; and
a retrieval unit that retrieves the loading order by rearranging an order of the objects included in each block of the plurality of blocks, and rearranging an order of the plurality of blocks,
wherein the allocation unit sets a total of the work times for the objects included in each block to be equal to or shorter than a value of a product of the number of objects included in each block and the first time, and sets the number of blocks in the plurality of blocks to be at least two and smaller than the number of objects in the plurality of objects.

10. The information processing device according to claim 9, wherein the allocation unit sets the number of blocks in the plurality of blocks to a maximum number, under a condition that a total of the work times for the objects included in each block is equal to or shorter than a value of a product of the number of objects included in each block and the first time.

11. The information processing device according to claim 9, wherein the retrieval unit retrieves the loading order based on a constraint condition for a work order of the objects.

12. The information processing device according to claim 9, further comprising a display device that displays a result of retrieval of the loading order.
